(19) United States
(12) Patent Application Publication
(10) Pub. No.: US 2002/0175232 A1
(43) Pub. Date: Nov. 28, 2002

(54) Solidified load protection system for grinding mills

(76) Inventors: Serge Louis Scuccato, Ontario (CA); Peter Duncan Fox-Thomas, Ontario (CA)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/681,721

(22) Filed: May 25, 2001

(51) Int. Cl. B02C 25/00

(52) U.S. Cl. 241/30; 241/33; 241/301

(57) ABSTRACT

A grinding mill assembly includes a mill shell, a pair of mill bearings supporting the mill, a motor configured to drive said mill shell, and at least one of a noise sensor and a vibration sensor. The at least one sensor generating an output signal indicative of whether a charge within the mill shell has cascaded. In addition, the grinding mill assembly includes at least one position sensor to determine a position of the mill shell. The grinding mill assembly also includes a solidified load panel comprising a controller configured to receive and process the output signal to determine if the charge within the mill has cascaded prior to the mill shell reaching a predetermined location.

### BACKGROUND OF INVENTION

This invention relates generally to mining operations and, more particularly, to grinding mills utilized in mining operations.

Grinding mills are utilized to grind ore into a fine particle at which point the specific mineral can be extracted through a chemical process. Different types of mills are used for reducing a particle size of the ore. The mill types include Autogenous (AG) Mills, Semi-Autogenous (SAG) Mills, Ball Mills, Rod Mills, and Regrind Mills. Some mills are driven through gears by using either a single pinion or multiple pinions connected to a common girth gear surrounding the mill. These pinions may be driven at fixed or variable speed directly using low speed motors, or indirectly through unit gearboxes using higher speed motors. Other mills are driven directly by having the drive motor rotor mounted directly onto the mill structure. These motors are powered by a variable speed low frequency drive. This arrangement is referred to as a Gearless Drive and the motor is referred to as a Ring Motor or a Wraparound Motor. The choice between fixed speed and variable speed is usually determined by the needs of the grinding process.

All types of mills typically operate on one basic principle, which is to elevate the materials within a cylindrically shaped mill to a point where the material tumbles to a bottom of the mill. The material within the mill is referred to as the charge. Typically, the charge is a combination of the ore to be ground, the grinding media, e.g., balls, rods, and others, and the transport mechanism, e.g., water. Elevating the charge is achieved by rotating the mill. The combined action of impact, falling, tumbling, and sliding of the ore and the grinding media effectively reduces the particle size of the ore as it passes through the mill.

The behavior of the charge during the initial mill start should be monitored to avoid the risk of serious mechanical damage to the mill. The behavior of the charge during starting is quite different from the behavior of the charge when the mill is operating at full operating speed. One reason for the different behavior is that the charge cascade angle is less during starting than at full operating speed. During the start, the cascade angle is referred to as the Static Cascade Angle. The charge particles have not gone into motion, as the mill has not reached full operating speed. Another reason for the different behavior is that during starting, the charge center of gravity is closer to the mill, whereas at full operating speed, many of the charge particles are in flight and are dispersed. A further reason for the differences is that during starting, the net amount of the charge being elevated is greater since the particles are not in motion and are in contact with the mill shell. In addition, at starting, the centrifugal force on the charge is minimal which typically allows the charge to slide at an earlier mill rotation point.

When the mill is stopped, e.g., for maintenance or operating reasons, the charge comes to rest at the bottom of the mill. The charge material then begins to settle and under it own weight, the particles compress together and can, in a relatively short time, compact into a solidified or partially solidified mass. The settled charge is typically referred to in the mill grinding industry as a Cemented Charge. If an attempt is now made to start and accelerate the mill in this condition, the charge may adhere to the mill shell and continue to turn with the mill beyond a Static Cascade Angle. If the mill acceleration is rapid, as would be the case for a clutch start, the centrifugal force will encourage the charge to stick to the mill shell as the mill continues to rotate to the 90 degrees mill rotation point. If the condition persists, the mill rotation continues to the point where the weight of the charge (due to gravity) exceeds the combination of the charge-to-shell adhesion forces and the centrifugal forces. The charge then falls. The falling charge has the potential of causing catastrophic damage to the mill and is referred to as a Dropped Charge condition.

### SUMMARY OF INVENTION

In one aspect, a grinding mill assembly includes a mill, a pair of mill bearings supporting the mill, a motor configured to drive the mill, at least one of a noise sensor and a vibration sensor, and a solidified load panel including a controller. A method for determining whether a charge within the grinding mill assembly has cascaded at start-up comprises generating a sensor output signal indicative of charge movement within the mill, receiving the output signal at the solidified load panel controller, and processing the output signal to determine if the charge within the mill has cascaded.

In another aspect, a grinding mill assembly includes a mill, a pair of mill bearings supporting the mill, and a motor configured to drive the mill. A load protection system for the grinding mill assembly comprises at least one of a noise sensor and a vibration sensor. The at least one sensor is mounted to the grinding mill assembly and is configured to generate an output signal indicative of movement of a charge within the mill. The load protection system further comprises a solidified load panel including a controller configured to receive and process the output signal to determine if the charge within the mill has cascaded.

In a further aspect, a solidified load panel for a grinding mill assembly comprises a controller. The grinding mill assembly includes a mill, a pair of mill bearings supporting the mill, a motor configured to drive the mill, and at least one of a noise sensor and a vibration sensor. The at least one sensor is configured to generate an output signal indicative of movement of a charge within the mill. The solidified load panel controller is configured to receive and process the output signal to determine if a charge within the mill has cascaded.

In a still further aspect, a grinding mill assembly comprises a mill, a pair of mill bearings supporting the mill, a motor configured to drive the mill, and at least one of a noise sensor and a vibration sensor. The at least one sensor is configured to generate an output signal. The grinding mill assembly also comprises a solidified load panel comprising a controller configured to receive and process the output signal to determine if a charge within the mill has cascaded.

### BRIEF DESCRIPTION OF DRAWINGS

FIG. 1 is a schematic view of a cross section of a mill shell including a charge in an at rest position.

FIG. 2 is a schematic view of a cross section of the mill shell shown in FIG. 1 after the mill shell has started to rotate.

FIG. 3 is a schematic view of a cross section of the mill shell shown in FIG. 1 after the mill shell has rotated to the static cascade point.

FIG. 4 is a schematic view of a cross section of the mill shell shown in FIG. 1 after the static cascade angle has been reached by the charge.

FIG. 5 is a schematic view of a cross section of the mill shell shown in FIG. 1 at full operating speed.

FIG. 6 is a schematic view of a grinding mill assembly in accordance with one embodiment of the present invention.

### DETAILED DESCRIPTION

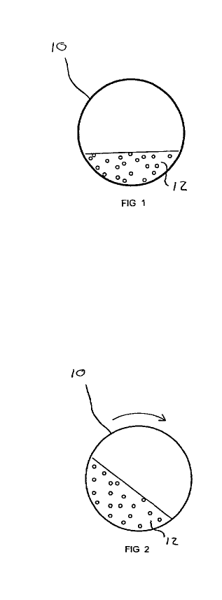

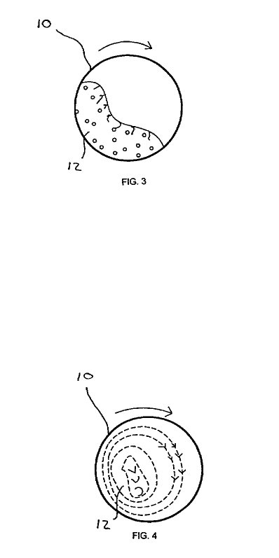

FIGS. 1 through 5 are schematic views of a cross section of a mill shell 10 including a charge 12 illustrating a known starting interaction between mill shell 10 and charge 12. In FIG. 1, mill shell 10 and charge 12 are at rest, and charge 12 is located in a bottom of mill shell 10. In FIG. 2, mill shell 10 has begun a clockwise rotate. Charge 12 rotates with mill shell 10 and remains stationary with respect to mill shell 10. In FIG. 3, the angle of rotation of mill shell 10 has increased to the static cascade point and charge 12 begins to cascade and slump cracks begin to form. In FIG. 4, the Static Cascade Angle has been reached by charge 12 and charge 12 begins to slide and tumble. The Static Cascade Angle refers to the amount of rotation, in degrees, the mill shell has rotated from its at rest position to the point where the static charge in the mill shell starts to crumble and cascade. Some of the charge particles are projected into flight at this time. Since mill shell 10 has not yet reached full operating speed, the centrifugal force is less than that which occurs at full operating speed and charge 12 therefore begins to slide at a smaller angle.

On reaching mill full operating speed, the centrifugal force on charge 12 is at its maximum, resulting in a larger charge cascade angle. This larger charge cascade angle is referred to as the Dynamic Cascade Angle. The Dynamic Cascade Angle is always greater than the Static Cascade Angle due to the additional centrifugal force acting on the charge when the mill shell is running at full operating speed.

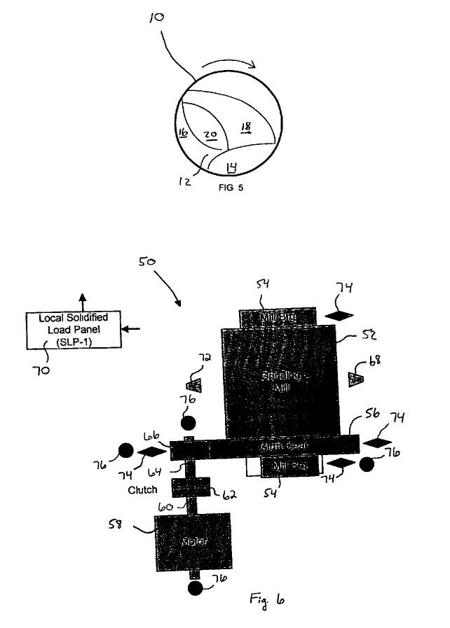

FIG. 5 illustrates mill shell 10 at full operating speed and charge 12 includes many particles that are in dynamic motion. Charge 12 includes four zones while mill shell 10 is at full operating speed. The first zone is Zone 14 which includes particles that are accelerated at mill shell speed. A second zone, Zone 16 includes particles that are being elevated at shell speed. A third zone, Zone 18 includes particles that are in flight, and a fourth zone, Zone 20 includes particles tumbling and sliding.

The mill Critical Speed is defined as the speed at which the centrifugal force is equal to the weight of the charge. At the mill critical speed, no grinding of the charge takes place since the charge remains pinned against the shell of the mill. Typically, mills are operated at about 60% to about 86% of critical speed. The mill operating speed is ultimately adjusted to provide an appropriate amount of grinding for the given charge.

It has been determined, through field testing, that a Static Cascade Angle of a non-solidified charge, at speeds below about 10% of the critical speed, is approximately 40 to 45 degrees. At full operating speed, a non-solidified charge tumbles at the Dynamic Cascade Angle, which is approximately 70 to 80 degrees. Although these angles represent the behavior of a typical charge, the cascade angles can change depending on the selected mill critical speed and on the specific design and size of any shell lifters.

A fixed speed mill will either use a clutch or a motor soft-start technology to accelerate the mill to operating speed. In applications that use clutches, the motors are accelerated to full speed with the clutches disengaged. The mills are then accelerated to full operating speed within about four to about five seconds by engaging the clutches, which connects the motors to the mill pinions. The mills are accelerated non-linearly and reach a top speed within about one half of one revolution. The clutch applied air is throttled, such that full air pressure is reached in approximately six seconds.

For applications that use soft-start technology, the mills are started and accelerated using power electronic devices, or adjustable rotor rheostats in the case of wound rotor induction motors, to limit the inrush current and still deliver the torque required to accelerate the mill. In these cases, the mills typically reach a top speed in about 10 to about 15 seconds.

Variable speed mills use a variety of drive technologies to control motor acceleration, speed, position, and torque. For variable speed mills, the motor or motors are directly connected to the mill and do not require clutches, although clutches are often used to provide short circuit protection for the gears. In the case of gearless mills, starting is totally controlled by the drive and the mill is accelerated at a controlled rate of approximately 1% per second. The mill therefore reaches full operating speed in approximately 100 seconds.

Since a solidified charge can be catastrophic to the mill mechanical system, a solidified charge must be detected before the mill has rotated above a potentially destructive position, i.e., before the mill has rotated about 90 degrees beyond its at rest position. When a mill begins to turn, the charge is stationary within the mill shell. Since there is no relative movement between the charge and the mill shell, minimal noise is generated within the mill. When the charge begins to cascade, the charge begins to slide and tumble and a characteristic noise is generated by the cascading charge. This characteristic noise can be detected by an appropriately located noise sensing system. The noise sensing system can identify the characteristic noise above any background noise, which may be present. This characteristic noise is sometimes referred to as a Noise Signature of the charge. In addition to the noise sensors, the mill rotational position is tracked to measure the degrees of mill rotation from the mill at rest position.

Another method of detecting that the charge has cascaded is to measure the vibration level of certain components of the mill. Prior to the charge cascading, minimal vibration is expected. However, an increased level of vibration is expected at the mill charge cascade point. Vibration measuring equipment can be used to detect the presence of this increased vibration.

FIG. 6 is a schematic view of a grinding mill assembly 50 including a mill shell 52, a pair of mill bearings 54 supporting mill shell 52, a girth gear 56 connected to mill shell 52, and a motor 58. Motor 58 includes a motor shaft 60 extending to a clutch 62. A pinion shaft 64 extends from clutch 62 to a pinion 66 which is connected to girth gear 56. In an exemplary embodiment, for a grinding mill assembly that rotates clockwise, assembly 50 includes a first noise sensor 68, for example, a Norsonic Measuring Microphone, NOR-1210 available from Scantek in Silver Springs, Md., USA, connected to a solidified load panel 70, for example, an integrated control unit by GE Power Solutions Engineering, Peterborough, Ontario, Canada including a controller (not shown). The controller is located within solidified load panel 70. Noise sensor 68 is mounted proximal to grinding mill assembly 50 and is located adjacent a side of mill shell 52. In an alternative embodiment, for a grinding mill assembly that rotates counterclockwise, assembly 50 includes both first noise sensor 68 and second noise sensor 72 connected to solidified load panel 70. Second noise sensor 72 is mounted proximal to grinding mill assembly 50 and is located adjacent a side of mill shell 52.

In an alternative embodiment, grinding mill assembly 50 includes at least one vibration sensor 74 located at one of girth gear 56, pinion 66 and one of mill bearings 54. In an exemplary embodiment, the vibration sensor is a casing-mounted #330525 vibration/acceleration transducer available from Bently-Nevada, 1631 Bently Parkway, South Minden, Nev., USA. Vibration sensor 74 is electronically connected to solidified load panel 70. Although FIG. 6 illustrates multiple vibration sensors 74, in the alternative embodiment, grinding mill assembly 50 includes only one vibration sensor 74. In a further alternative embodiment, grinding mill assembly includes more than one vibration sensor 74.

Grinding mill assembly 50 also includes a position sensor 76 located at one of girth gear 56, pinion 66 and pinion shaft 64 and connected to solidified load panel 70. In an alternative embodiment, motor shaft 60 does not include a clutch and position sensor 76 is located at motor shaft 60. Although more than one position sensor 76 is shown in FIG. 6, in the further embodiment, grinding mill assembly 50 includes only one position sensor 76. In an alternative further embodiment, grinding mill assembly 50 includes more than one position sensor 76.

In a still further alternative embodiment, grinding mill assembly 50 includes at least one noise sensor 68, 72 and at least one vibration sensor 74. In another embodiment, grinding mill assembly includes at least one position sensor 76 in combination with at least one noise sensor 68, 72 and at least one vibration sensor 74. In yet another embodiment, grinding mill assembly 50 includes at least one position sensor 76 in combination with either at least one noise sensor 68, 72 or at least one vibration sensor 74.

A method for determining whether a charge within a grinding mill assembly has cascaded at start-up includes generating a sensor output signal indicative of charge movement within the mill shell. For example, when the sensor is a noise sensor, the method includes sensing a noise in the mill indicative of a cascading charge within the mill. Alternatively, when the sensor is a vibration sensor, the method includes sensing a vibration in the grinding mill assembly indicative of a cascading charge within the mill. The method further includes receiving the output signal at the solidified load panel controller, and processing the output signal to determine if the charge within the mill shell has cascaded before the mill shell has rotated to a predetermined position. In addition, the method includes generating a position sensor output indicative of a relative position of the mill shell with respect to a mill shell starting position. The method also includes receiving the position sensor output at the solidified load panel controller and processing the position sensor output signal to determine a rotation position of the mill shell.

The data from the sensors allow detection of a solidified load condition and enable the initiation of an immediate mill shutdown before the charge is elevated to a destructive point. The status of the mill charge can be determined by the controller by applying logic to the collected and received information. The status determination can be used to allow the mill to continue turning if acceptable noise and/or vibration has been detected within the acceptable rotational criteria, i.e. no solidified charge. Alternatively, the status determination can be used to remove power from the mill if acceptable noise and/or vibration has not been detected within the acceptable rotational criteria, i.e., a solidified charge. On removing power to the mill, the mill rolls back to the at rest position with the charge at the zero bottom position. In one embodiment, the solidified charge is annunciated at the solidified load panel and the condition is also annunciated at a customer's Mill Control Station.

The above described assembly has been described with respect to a typical mill driven by a single motor geared to the mill through a clutch. In alternative embodiments, the sensor arrangement described above is used for mill direct drive arrangements. In addition, the mill rotational position is obtained from a connected drive technology when clutches are not used in the mill mechanical arrangement.

While the invention has been described in terms of various specific embodiments, those skilled in the art will recognize that the invention can be practiced with modification within the spirit and scope of the claims.

1. A method for determining whether a charge within a grinding mill assembly has cascaded at start-up, the grinding mill assembly including a mill shell, a pair of mill bearings supporting the mill shell, a motor configured to drive the mill shell, at least one of a noise sensor and a vibration sensor, and a solidified load panel including a controller, said method comprising the steps of:
generating a sensor output signal indicative of charge movement within the mill shell;
receiving the output signal at the solidified load panel controller; and
processing the output signal to determine if the charge within the mill shell has cascaded.

2. A method in accordance with claim 1 wherein the grinding mill assembly further includes at least one position sensor, said method further comprising:
generating a position sensor output indicative of a position of the mill shell;
receiving the position sensor output at the solidified load panel controller; and
processing the position sensor output signal to determine a rotation position of the mill shell.

3. A method in accordance with claim 2 further comprising processing the position sensor output signal to determine a relative position of the mill shell with respect to a mill shell starting position.

4. A method in accordance with claim 1 wherein the at least one sensor is a noise sensor located adjacent the mill shell, said method further comprising sensing a noise in the mill shell indicative of a charge within the mill shell cascading.

5. A method in accordance with claim 1 wherein the mill assembly further includes a girth gear mounted to the mill shell and the motor includes a shaft having a pinion, the pinion contacting the girth gear, the at least one sensor is a vibration sensor mounted to at least one of the girth gear, the pinion, and at least one of the mill bearings, said method further comprising sensing a vibration in the grinding mill assembly indicative of a charge within the mill shell cascading.

6. A method in accordance with claim 2 further comprising processing the position sensor output signal to determine whether the charge within the mill shell has cascaded before the mill shell has rotated to a predetermined position.

7. A load protection system for a grinding mill assembly including a mill shell, a pair of mill bearings supporting the mill shell, and a motor configured to drive the mill shell, said system comprising:
at least one of a noise sensor and a vibration sensor, said at least one sensor mounted to the grinding mill assembly and configured to generate an output signal indicative of movement of a charge within the mill shell; and
a solidified load panel including a controller configured to receive and process the output signal to determine if the charge within the mill shell has cascaded.

8. A load protection system in accordance with claim 7 wherein the motor includes a motor shaft connected to the mill shell, said at least one sensor mounted to at least one of the motor shaft and at least one of the mill bearings.

9. A load protection system in accordance with claim 7 wherein, if the charge has not cascaded by a predetermined mill shell position, said controller configured to generate an output signal sufficient to remove power from the mill shell.

10. A load protection system in accordance with claim 7 wherein said at least one sensor is a noise sensor located adjacent the mill shell.

11. A load protection system in accordance with claim 7 wherein the mill shell includes a girth gear and the motor shaft includes a pinion, said at least one sensor is a vibration sensor mounted to at least one of the girth gear, the pinion, and at least one of the mill bearings.

12. A load protection system in accordance with claim 7 wherein the mill shell includes a girth gear and the motor shaft includes a pinion contacting the girth gear, the mill assembly further includes at least one position sensor mounted to at least one of the motor shaft, the pinion, and the girth gear, the position sensor configured to generate an output signal, said controller configured to receive and process the position sensor output signal to determine a position of the mill shell.

13. A load protection system in accordance with claim 7 wherein said controller configured to determine a number of degrees the mill shell has rotated from the mill shell starting position.

14. A solidified load panel for a grinding mill assembly, the assembly including a mill shell, a pair of mill bearings supporting the mill shell, a motor configured to drive the mill shell, and at least one of a noise sensor and a vibration sensor, the at least one sensor configured to generate an output signal indicative of movement of a charge within the mill shell, said panel comprising a controller configured to receive and process the output signal to determine if a charge within the mill shell has cascaded.

15. A solidified load panel in accordance with claim 14 wherein the grinding mill assembly further includes at least one position sensor, said controller configured to receive and process the position sensor signal to determine a position of the mill shell.

16. A solidified load panel in accordance with claim 15 wherein said controller further configured to:
determine whether the charge has cascaded prior to the mill shell reaching a first position; and
generate an output signal sufficient to remove power from the mill assembly if the charge within the mill shell has not cascaded prior to the mill shell reaching the first position.

17. A grinding mill assembly comprising:
a mill shell;
a pair of mill bearings supporting said mill shell;
a motor configured to drive said mill shell;
at least one of a noise sensor and a vibration sensor, said at least one sensor configured to generate an output signal; and
a solidified load panel comprising a controller configured to receive and process the output signal to determine if a charge within said mill shell has cascaded.

18. An assembly in accordance with claim 17 further comprising a position sensor configured to generate a position sensor output signal indicative of a position of the mill shell.

19. An assembly in accordance with claim 18 wherein said controller further configured to:
receive the position sensor output signal; and
process the position sensor output signal to determine a relative position of the mill shell with respect to a mill shell starting position.

20. An assembly in accordance with claim 18 wherein said controller further configured to:
determine whether the charge has cascaded prior to the mill shell reaching a first position; and
generate an output signal sufficient to remove power from the mill if the charge within the mill shell has not cascaded prior to the mill shell reaching the first position.

21. An assembly in accordance with claim 17 wherein said motor comprises a shaft including a pinion, said mill shell comprising a girth gear, said pinion contacting said girth gear.

22. An assembly in accordance with claim 17 wherein said at least one sensor comprising a vibration sensor, said vibration sensor mounted to at least one of the girth gear, the pinion, and at least one of the mill bearings.

23. An assembly in accordance with claim 17 wherein the at least one sensor is a noise sensor mounted to the mill assembly.
